(19) United States
(12) Patent Application Publication
(10) Pub. No.: US 2015/0336130 A1
(43) Pub. Date: Nov. 26, 2015

(54) CURING METHODS AND PRODUCTS PRODUCED THEREFROM

(71) Applicant: ARMSTRONG WORLD INDUSTRIES, INC., Lancaster, PA (US)

(72) Inventors: Larry W. LEININGER, Akron, PA (US); Dong TIAN, Lancaster, PA (US)

(21) Appl. No.: 14/760,060

(22) PCT Filed: Jan. 17, 2014
(86) PCT No.: PCT/US14/12016

§ 371 Date: Jul. 9, 2015

Related U.S. Application Data
(60) Provisional application No. 61/753,810, filed on Jan. 17, 2013.

(51) Int. Cl. B05D 3/06

(52) U.S. Cl. CPC B05D 3/067

(57) ABSTRACT

Described herein are methods for producing a wear layer on a substrate comprising: applying a radiation curable composition comprising an acrylate component to a surface of a substrate; and irradiating the substrate to which said composition has been applied with a source of radiation having a wavelength from 100-280 rim, to form a wear layer. Uses of the products produced by the methods are also described herein.

### CROSS-REFERENCE TO RELATED PATENT APPLICATIONS

This application claims priority to U.S. Provisional Patent Application Ser. No. 61/753,810, filed Jan. 17, 2013, the entirety of which is hereby incorporated herein by reference.

### BACKGROUND

Radiation curable coatings, such as ultraviolet curable coatings, are applied to various types of substrates to enhance their durability and finish. These radiation curable coatings are typically mixtures of resins, oligomers, and monomers that are radiation cured after being applied to the substrate. Radiation curing polymerizes and/or cross-links the resins, monomers and oligomers to produce a coating having desirable properties such as abrasion and chemical resistance. Radiation curable coatings of this type are often referred to as topcoats or wear layers and are used in flooring applications, such as on linoleum, hardwood, resilient sheet and tile flooring.

Known UV curable coatings may be cured by conventional UV lamps, such as mercury arc lamps or microwave powered, electrode-less mercury lamps, which emit the strongest wavelengths in the UVA range of 315 to 400 nm. Although UV curing has been used in the art to cure coatings, a continuing need exists for improved UV curable compositions and methods of curing.

### SUMMARY

Some embodiments of the present invention provide methods for producing a wear layer on a substrate comprising: applying a radiation curable composition comprising an acrylate component to a surface of a substrate; and irradiating the substrate to which said composition has been applied with a source of radiation having a wavelength from 100-280 nm, to form a wear layer.

Further embodiments provide a product produced by any one of the methods described herein.

### DETAILED DESCRIPTION

As used herein, “UVV” refers to UV radiation having the strongest wavelengths between 400-450 nm.

As used herein, “UVA” refers to UV radiation having the strongest wavelengths between 315-400 nm.

As used herein, “UVB” refers to UV radiation having the strongest wavelengths between 280-315 nm.

As used herein, “UVC” refers to UV radiation having the strongest wavelengths between 100-280 nm, which is also known as germicidal UV.

As used herein, “VUV” refers to UV radiation having the strongest wavelengths between 10-200 nm. Excimer lamps typically operate in VUV spectrum.

Some embodiments of the present invention provide a method for producing a wear layer on a substrate comprising: applying a radiation curable composition comprising an acrylate component to a surface of a substrate; and irradiating the substrate to which said composition has been applied with a source of radiation having a wavelength from 100-280 nm, to form a wear layer.

In some embodiments, the method further comprises the step of pre-curing the radiation curable composition prior to the step of applying the composition to the substrate. In some embodiments, the pre-curing comprises irradiating the radiation curable composition with a source of radiation having a wavelength of from 100-280 nm.

In some embodiments, the pre-curing comprises irradiating the radiation curable composition with a source of UVA, UVB, UVC, UVV or VUV radiation.

In some embodiments, the methods further comprise the step of heating said substrate to a temperature of from about 65° F. (18° C.) to about 150° F. (66° C.) prior to irradiating said composition.

In some embodiments, the composition further comprises an amine synergist. In some embodiments, the composition comprises from about 0.1 to about 25 wt. % of an amine synergist. In some embodiments, the composition comprises from about 1 to about 5 wt. % of an amine synergist. In some embodiments, the composition comprises from about 2 to about 3 wt. % of an amine synergist.

In some embodiments, the composition further comprises an abrasive.

In some embodiments, the radiation curable composition is cured in an inert environment, such as under a nitrogen blanket. The nitrogen flow rate of the nitrogen blanket is from about 10 Nm³/hour to about 100 Nm³/hour. In some embodiments, the nitrogen flow rate is about 40 Nm³/hour.

In some embodiments, the coated substrate is irradiated in an environment having a low oxygen concentration, such as from about 50 to about 2000 ppm of oxygen concentration. In some embodiments, the coated substrate is irradiated in an environment having an oxygen concentration of from about 75 to about 1500 ppm. In some embodiments, the coated substrate is irradiated in an environment having an oxygen concentration of from about 75 to about 150 ppm. In some embodiments, the coated substrate is irradiated in an environment having an oxygen concentration of from about 75 to about 115 ppm. In some embodiments, the coated substrate is irradiated in an environment having an oxygen concentration of from about 100 to about 200 ppm. In some embodiments, the coated substrate is irradiated in an environment having an oxygen concentration of from about 1500 to about 1700 ppm.

In some embodiments, the coated substrate is irradiated at a line speed of from about 10 ft./min (3 m/min) to about 60 ft./min (18 m/min). In other embodiments, the coated substrate is irradiated at a line speed of from about 20 ft./min (6 m/min) to about 50 ft./min (15 m/min). In still further embodiments, the coated substrate is irradiated at a line speed of 38 ft./min (12 m/min).

In some embodiments, the radiation curable composition comprises from about 65 wt. % to about 95 wt. % of an acrylate component. In some embodiments, the radiation curable composition comprises from about 70 wt. % to about 85 wt. % of an acrylate component.

In some embodiments, the acrylate component comprises an acrylate selected from polyester acrylate; urethane acrylate; epoxy acrylate; silicone acrylate; and a combination of two or more thereof.

In some embodiments, the source of radiation used to irradiate the substrate to which said composition has been applied, comprises an amalgam germicidal lamp. In some embodiments, the substrate to which the coating has been applied is irradiated for a time and intensity sufficient to provide a total energy density of from about 0.1 J/cm² to about 0.4 J/cm².

In some embodiments, the substrate to which the coating has been applied is irradiated a plurality of times. In further embodiments, the substrate to which the coating has been applied is irradiated with at least one of UVA, UVB, UVC, UVV or VUV radiation. In other embodiments, the substrate to which the coating has been applied is irradiated with at least one of UVA, UVB, UVC, UVV or VUV radiation, after it has been irradiated with a source of radiation having a wavelength from 100-280.

In some embodiments, the pre-curing is carried out at a temperature of from about 110° F. to about 125° F.

In some embodiments, the composition further comprises a dye or pigment.

In some embodiments, the radiation curable composition is applied to the substrate in an amount sufficient to provide a coating having a density of from about 1 g/m² to about 3 g/m².

in some embodiments, the substrate to which said composition has been applied is irradiated with a source of radiation having a peak of 254 nm and a lower peak at 185 nm.

Some embodiments provide a product produced by any one of the methods described herein, for use as a flooring material.

Materials employed in the formulations disclosed include acrylate resins such as EC6360 polyester acrylate, EM 2204 tricyclodecane dimethanol diacrylate, EC6154B-80, EC6115J-80, EC6142H-80, and EC6145-100 all available from Eternal; Actilane 579 and Actilane 505 available from AkzoNobel; Roskydal TP LS 2110, Roskydal UA VP LS 2266, Roskydal UA VP LS 2380, Roskydal UA VP LS 2381 (XD042709), Roskydal UA XP 2416, Desmolux U200, Desmolux U 500 acrylate, Desmolux U680H, Desmolux XP2491, Desmolux XP2513 unsaturated aliphatic urethane acrylate, Desmolux XP 2738 unsaturated aliphatic allophanate, Desmolux P175D, Roskydal UA TP LS 2258, Roskydal UA TP LS 2265, and Roskydal UA XP 2430 all available from Bayer; CD 406 cylohexane dimethanol diacrylate, CD420, CD611, CN965, CN966 A80, CN966 J75, CN981, CN991, CN2920, CN2282, CN985B88, CN2003B, 2-EHA, CN 307 hydrophobic acrylate ester, CN 308 hydrophobic acrylate ester, hydrophobic acrylate ester, CN 989 aliphatic urethane acrylate oligomer, CN 9007aliphatic urethane acrylate, CN 9009 aliphatic urethane acrylate, CN 9011aliphatic urethane acrylate, CN 9014 hydrophobic urethane acrylate, SR 339 2-phenoxyethyl acrylate, SR 531 cyclic trimethylolpropane formal acrylate, SR 540 ethoxylated(4) bisphenol A dimethacrylate, SR 3010, SR 9035, SR833S tricyclodecane dimethanol dimethacrylate, SR531 2-phenoxyethyl acrylate, SR 351, SR 306, SR395, SR 238, SR399, SR324, SR257, SR-502, SR203 all available from Sartomer; Disperbyk 2008 acrylic block copolymer from BYK Chemie; Ebecryl 230, Ebecryl 270, Ebecryl 4830, Ebecryl 4833, Ebecryl 4883, Ebecryl 8402, Ebecryl 8405, Ebecryl 8411, Ebecryl 8807, and Ebecryl 809, Ebecry 114 2-phenoxyethyl acrylate, dipropylene glycol diacrylate (DPGDA), neopentyl glyco propoxylate (2) diacrylate (NPG(PO)2DA), trimethylolpropane ethoxy triacrylate (TMPEOA), isobornyl acrylate (IBOA), Ebecryl 114, and Ebecryl 381 all available from Cytec; and Polyfox 3305, PolyFox 3320, and Polyfox 3510, all available from Omnova and AR-25 polyester acrylate. AR-25 may be formed according to the procedure of Example 7 of U.S. Pat. No. 5,891,582, the teachings of which are incorporated herein by their entirety.

In embodiments in which the resin includes a urethane acrylate and/or polyester acrylate, the ultraviolet curable acrylate resin component also may include a reactive diluent where the coating is to be used in flooring applications. If employed, the reactive diluent is present between about 0.1% to about 90% by weight of the composition, more typically between about 5% to about 70% by weight. Reactive diluents that may be employed include but are not limited to (meth)acrylic acid, isobornyl (meth)acrylate, isodecyl (meth)acrylate, hexanediol di(meth)acrylate, N-vinyl formamide, tetraethylene glycol (meth)acrylate, tripropylene glycol(meth)acrylate, neopentyl glycol di(meth)acrylate, ethoxylated neopentyl glycol di(meth)acrylate, propoxylated neopentyl glycol di(meth)acrylate, trimethylolpropane tri(meth)acrylate, ethoxylated trimethylolpropane tri(meth)acrylate, propoxylated trimethylolpropane tri(meth)acrylate, ethoxylated or propoxylated tripropylene glycol di(meth)acrylate, pentaerythritol tri(meth)acrylate, pentaerythritol tetra(meth)acrylate, tris(2-hydroxy ethyl) isocyanurate tri(meth)acrylate and combinations thereof.

Photoinitiators that may be employed include any photoinitiator as is known in the art and which is activated by ultraviolet radiation may be used. The photoinitiator is usually, but not necessarily, a free radical photoinitiator. Suitable free radical photoinitiators include unimolecular (Norrish Type I and Type II), bimolecular (Type II), and biomolecular photosensitization (energy transfer and charge transfer). Exemplary classes of free radical photoinitiators that may be employed include, but are not limited to, diphenyl ketone, 1-hydroxycyclohexyl phenyl ketone, phenyl bis (2,4,6-trimethyl benzoyl)phosphine oxide, Esacure KTO-46 (a mixture of phosphine oxide, Esacure KIP 50 and Esacure TZT), 2,4,6-trimethylbenzoyldiphenyl phosphine oxide, isopropylthioxanthone, 1-chloro-4-propoxy-thioxanthone, 2,4-diethylthioxanthone, 2-chlorothioxanthone, camphorquinone, 2-ethyl anthraquinone, as well as Irgacure 1700, Irgacure 2020, Irgacure 2959, Irgacure 500, Irgacure 651, Irgacure 754, Irgacure 907, Irgacure 184 1-hydro-xyclohexyl phenyl ketone all available from Ciba. Other photoinitiators that may be employed include such as Speedcure BP and Speedcure 84 all available from Lampson and Benzophenone diphenyl ketone from Parke Davis.

Abrasives may be present in the coating compositions. Abrasives that may be employed include, but are not limited to: aluminum oxide, fluorite, apatite, feldspar, nepheline syenite, glass, quartz, ceramic, silicon nitride, silicon carbide (carborundum), tungsten carbide, titanium carbide, topaz, corundum/sapphire (Al₂O₃), diamond, and combinations thereof. A non-limiting example of an abrasive that may be employed is PWA30 alumina from Fujimi.

Flattening agents may be present in the coating compositions. Flattening agents that may be used re usually inorganic, typically silica, although organic flattening agents or a combination of inorganic and organic materials may be used as flattening agents. Examples of such flattening agents include but are not limited to Gasil UV70C silica from Ineos Silicas. ACEMATT HK125, ACEMATT HK400, ACEMATT HK440, ACEMATT HK450, ACEMATT HK460, ACEMATT OK412, ACEMATT OK 500, ACEMAT OK520, ACEMATT OK607, ACEMATT TS100, ACEMATT 3200, ACEMATT 3300 all available from Evonik; MPP-620XXF, Polyfluo 150, Propylmatte 31 all available from Micropowders; Ceraflour 914, Ceraflour 913 all available from BYK; Gasil ultraviolet70C, Gasil HP280, Gasil HP 860, Gasil HP 870, Gasil IJ 37, Gasil ultraviolet 55C all available from PQ Corporation; Minex 12, Minex 10, Minex 7 and Minex 4 all available from Unimin.

Amine synergist may be used in combination with the free radical photoinitiators. Examples of amine synergists include, but are not limited to, 2-ethylhexyl-4-dimethylamino benzoate, ethyl 4-(dimethylamine)benzoate, N-methyl diethanolamine, 2-dimethylamino ethylbenzoate, and butoxyethyl-4-dimethylamino benzoate, as well as CN373, CN383, CN384, CN386 and CN 371, all available from Sartomer; Ebecry P104, Ebecry P115, Ebecry 7100 all available from Cytec; and Roskydal UA XP 2299 available from Bayer. The range of the amine synergist is from 0.5% to about 15% by weight in the coating composition, more typically between about 1% to about 5% by weight.

Generally, UV curable compositions for use as protective coatings on substrates, such as flooring may be created without an extraneous solvent, or as either a solvent base or waterborne formulations that include a resin and a photoinitiator. The photoinitiator is one that is activated by UV. The photoinitiator is typically a free radical photoinitiator, but in some embodiments may also be a cationic initiator. In embodiments in which the free radical photoinitiator is not itself activated by exposure to UV radiation, an amine synergist may be used. A cationic initiator may also be used in combination with a photosensitizer to achieve activation by UV radiation.

The UV curable compositions include an ultraviolet curable acrylate resin such as urethane acrylates and/or polyester acrylate and one or more photoinitiator. Additional components may include abrasives and flattening agents. Typically a combination of multiple acrylate resins are present in the composition and together make up about 65 to about 95 percent by weight of the composition.

Any suitable acrylate resins may be used, although the compositions typically include at least one resin selected from the group consisting of urethane acrylates, polyester acrylates and combinations thereof. Urethane acrylates and polyester acrylates may be commercially obtained or prepared, for example, according to the procedures disclosed in U.S. Pat. Nos. 5,719,227, 5,003,026, and 5,543,232, as well as in U.S. Application Publication No. 2009/0275674, all of which are hereby incorporated by reference in their entireties.

Non-limiting examples of acrylate resins include any one or more of those mentioned above such as EC6360, EC6154B-80, EC6115J-80, EC6142H-80, and EC6145-100 all available from Eternal; Actilane 579 and Actilane 505 available from AkzoNobel; Roskydal TP LS 2110, Roskydal UA VP LS 2266, Roskydal UA VP LS 2380, Roskydal UA VP LS 2381 (XD042709), Roskydal UA XP 2416, Desmolux U200, Desmolux U680H, Desmolux XP2491, Desmolux XP2513, Desmolux P175D, Roskydal UA TP LS 2258. Roskydal UA TP LS 2265, and Roskydal UA XP 2430 all available from Bayer; CN965, CN966 A80, CN966 J75, CN981, CN991, CN2920, CN2282, CN985B88, CN2003B, SR 3010, SR 9035, SR833S, SR531, CD420, CD611, SR 351, SR 306, SR395, SR 238, SR399, 2-EHA, SR324, SR257, SR-502, and SR203 all available from Sartomer; Ebecryl 230, Ebecryl 270, Ebecryl 4830, Ebecryl 4833, Ebecryl 4883, Ebecryl 8402, Ebecryl 8405, Ebecryl 8411, Ebecryl 8807, and Ebecryl 809, dipropylene glycol diacrylate (DPGDA), neopentyl glycol propoxylate (2) diacrylate (NPG(PO)2DA), trimethylolpropane ethoxy triacrylate (TMPEOA), isobornyl acrylate (IBOA), Ebecryl 114, and Ebecryl 381 all available from Cytec; and Polyfox 3305, PolyFox 3320, and Polyfox 3510, all available from Omnova, The foregoing acrylates are presented by way of example only and not by way of limitation.

The compositions may include about 0.5% to about 10% by weight of a photoinitiator, more typically between about 1% to about 5% by weight photoinitiator, that is activated by ultraviolet radiation. Any photoinitiator as is known in the art and which is activated by ultraviolet radiation may be used. The photoinitiator is usually, but not necessarily, a free radical photoinitiator. Suitable free radical photoinitiators include unimolecular (Norrish Type I and Type II), bimolecular (Type II), and biomolecular photosensitization (energy transfer and charge transfer). Exemplary classes of free radical photoinitiators that may be employed include, but are not limited to, diphenyl ketone, 1-hydroxycyclohexyl phenyl ketone, phenyl bis (2,4,6-trimethyl benzoyl)phosphine oxide, Esacure KTO-46 (a mixture of phosphine oxide, Esacure KIP150 and Esacure TZT), 2,4,6-trimethylbenzoyldiphenyl phosphine oxide, isopropylthioxanthone, 1-chloro-4-propoxy-thioxanthone, 2,4-diethylthioxanthone, 2-chlorothioxanthone, camphorquinone, 2-ethyl anthraquinone, as well as Irgacure 1700, Irgacure 2020, Irgacure 2959, Irgacure 500, Irgacure 651, Irgacure 754, Irgacure 907 all available from Ciba. Other photoinitiators that may be employed include such as Speedcure BP and Speedcure 84 all available from Lampson and Benzophenone diphenyl ketone from Parke Davis.

Suitable free radical photoinitiators include unimolecular (Norrish Type I and Type II), bimolecular (Type II), biomolecular photosensitization (energy transfer and charge transfer). Exemplary classes of free radical photoinitiators that may be employed include but not limit to phenyl bis(2,4,6-trimethyl benzoyl) phosphine oxide, Esacure KTO-46 (a mixture of phosphine oxide, Esacure KIP 150 and Esacure TZT), 2,4,6-trimethylbenzoyldiphenyl phosphine oxide, isopropylthioxanthone, 1-chloro-4-propoxy-thioxanthone, 2,4-diethylthioxanthone, 2-chlorothioxanthone, camphorquinone, and 2-ethyl anthranquinone. Suitable cationic photoinitiators include iodonium salts and sulfonium salts, such as triarylsulfonium hexafluoroantimonate salts, triarylsulfonium hexafluorophosphate salts, and bis(4-methylphenyl)-hexatfluorophosphate-(1)-iodonium. Suitable photosensitizers for the cationic photoinitiators include isopropyl thioxanthone, 1-chloro-4-propoxy-thioxanthone, 2,4-diethyithioxanthone, and 2-chlorothioxanthone, all by way of example only.

In some cases, an amine synergist may be used in combination with the free radical photoinitiators. Examples of amine synergist include that may be employed include but are not limited to 2-ethylhexyl-4-dimethylamino benzoate, ethyl 4-(dimethylamine)benzoate, N-methyl diethanolamine, 2-dimethylamino ethylbenzoate, and butoxyethyl-4-dimethylamino benzoate, as well as CN371, CN373, CN383, CN384, CN386 all available from Sartomer; Ebecry P104, Ebecry P115, Ebecry 7100 all available from Cytec; and Roskydal UA XP 2299 available from Bayer. The range of the amine synergist is from 0.5% to about 15% by weight in the coating composition, more typically between about 1% to about 5% by weight. An amine synergist may be used with these free radical photoinitiators. Examples of amine synergist include, but are not limited to, 2-ethylhexyl-4-dimethylamino benzoate, ethyl 4-(dimethylamine)benzoate, N-methyl diethanolamine, 2-dimethylamino ethylbenzoate, and butoxyethyl-4-dimethylamino benzoate.

In embodiments in which the resin includes a urethane acrylate and/or polyester acrylate, the ultraviolet curable acrylate resin component also may include a reactive diluent where the coating is to be used in flooring applications. If employed, the reactive diluent is present in an amount of about 0.1% to about 90% by weight of the composition, more typically between about 5% to about 80% by weight.

Non-limiting examples of acrylate reactive diluents include, but are not limited to, (meth)acrylic acid, isobornyl (meth)acrylate, isodecyl (meth)acrylate, hexanediol di(meth)acrylate, N-vinyl formamide, tetraethylene glycol (meth)acrylate, tripropylene glycol(meth)acrylate, neopentyl glycol di(meth)acrylate, ethoxylated neopentyl glycol di(meth)acrylate, propoxylated neopentyl glycol di(meth)acrylate, trimethylolpropane tri(meth)acrylate, ethoxylated trimethylolpropane tri(meth)acrylate, propoxylated trimethylolpropane tri(meth)acrylate, ethoxylated or propoxylated tripropylene glycol di(meth)acrylate, pentaerythritol tri(meth)acrylate, pentaerythritol tetra(meth)acrylate, tris(2-hydroxy ethyl) isocyanurate tri(meth)acrylate and combinations thereof.

The UV curable compositions may be low gloss coatings that contain one or more flattening agents that may be dispersed within the composition reduce the gloss level of the cured composition. Flattening agents that may be used re usually inorganic, typically silica, although organic flattening agents or a combination of inorganic and organic materials may be used as flattening agents. Examples of such flattening agents that may be used include but are not limited to ACEMATT HK125, ACEMATT HK400, ACEMATT HK440, ACEMATT HK450, ACEMATT HK460, ACEMATT OK412, ACEMATT OK 500, ACEMATT OK520, ACEMATT OK607, ACEMATT TS100, ACEMATT 3200, ACEMATT 3300 all available from Evonik; MPP-620XXF, Polyfluo 150, Propylmatte 31 all available from Micropowders; Ceraflour 914, Ceraflour 913 all available from BYK; Gasil ultraviolet70C, Gasil HP280, Gasil HP 860, Gasil HP 870, Gasil IJ 37, Gasil ultraviolet 55C all available from PQ Corporation; Minex 12, Minex 10, Minex 7 and Minex 4 all available from Unimin.

Where a plurality of flattening agents is employed, the flattening agents may differ by chemistry (i.e., composition), particle size, particle size distribution, surface treatment, surface area and/or porosity. The total amount of flattening agent in the compositions may vary from about 1% to about 30% by weight, more typically between about 3% to about 15% by weight based on total weight of the composition.

The compositions also may include one or more abrasives and one or more surfactants. Abrasives that may be employed include but are not limited to PWA30 alumina from Fujimi. Surfactants that may be employed include but are not limited to BYK 3530 from BYK Chemie.

Flooring substrates to which the UV curable compositions may be applied may be of any size and include sheet goods such as linoleum. Examples of flooring include but are not limited to engineered wood; solid wood; tile that are cut from sheet goods; and individually formed tile, typically ranging from about one foot square to about three foot square, although tiles and other products may also be formed in other shapes, such as rectangles, triangles, hexagons or octagons. In some cases, such as in the case of tiles, engineered wood and solid wood, the flooring substrates may also be in the form of a plank, typically having a width in the range of about three inches to about twelve inches.

Linoleum is formed from compositions that include binders (so-called Bedford cement or B-cement of partly oxidized linseed oil and at least one resin as tack-producing agent), at least one filler and optionally at least one colorant. The fillers used are typically powdered softwood and/or powdered cork (if both powdered softwood and powdered cork are present at the same time, typically the weight ratio is 90:10) and/or chalk, kaolin, diatomaceous earth and barite. In addition, to stiffen the mass, one can add as fillers precipitated silicic acid and small amounts of water glass, such as water glass in an amount of up to about 15 wt. % in terms of the quantity of the layer.

The linoleum mix mass typically contains at least one colorant, such as an inorganic oxide such as titanium dioxide and/or an organic pigment, and/or other typical colorants. Any natural or synthetic dyes may be used as the colorant, as well as inorganic or organic pigments, alone or in any given combination. A typical linoleum composition contains, in terms of the weight of the linoleum layer, about 40 wt. % of binder, about 30 wt. % of organic substances, about 20 wt. % of inorganic (mineral) fillers and about 10 wt. % of colorant. Moreover, typical additives may be contained in the linoleum mix mass, such as processing aids, UV stabilizers, lubricating agents, dimension stabilizers and the like, which are chosen in dependence on the binder.

Examples of dimension stabilizers include but are not limited to chalk, barium sulfate, slate flour, silicic acid, kaolin, quartz flour, talc, lignin, cellulose, powdered glass, textile or glass fibers, cellulose fibers and polyester fibers, which may be used in a quantity of about 1 to about 20 wt. % in terms of the overall weight of the particular layer. The base layer of linoleum in the sheet material may be prepared with or without a carrier.

The linoleum mix mass is processed into skins and conveyed to a scraper or granulator, after which the mixed mass particles thus obtained are conveyed to a calendar and pressed, under pressure and a temperature of usually about 10° C. to about 150° C., onto jute, for example, as a base material. Then the sheet materials obtained are stored for 2 to 3 weeks in an aging chamber at about 80° C.

Typically, the ultraviolet curable compositions are deposited by roller coating or draw down onto a substrate such as flooring such as sheet linoleum as part of a continuous process at a desired line speed. Deposition of the UV curable compositions may be performed at about 60° F. (16° C.) to about 125° F. (52° C.), typically about 90° F. (32° C.) to about 115° F. (46° C.). The compositions may be applied to a thickness of about 0.1 mil (0.003 mm) to about 6 mil (0.15 mm), typically about 0.5 mil (0.01 mm) to about 1 mil (0.025 mm).

The UV curable compositions may be applied under a variety of atmospheres and over a range of atmospheric pressures. Suitable atmospheres include but are not limited to air and inert atmospheres such as N₂, CO₂, SF₆, He, Ar, or other gasses at pressures of about 7 to about 30 psi, typically about 0.8 to about 15 psi. The compositions also may be applied in vacuum, in which the composition is typically sprayed, extruded or otherwise applied onto a cold surface ranging from about 273K to about 78K and then exposed to a vacuum on the order of about 1×10⁻³ to about 1×10⁻⁸ Torr, followed by exposure to the UV source.

Where a coated flooring substrate such as coated sheet flooring such as coated linoleum sheet is exposed to UV, the coated flooring may be exposed to UV radiation by being passed under UV lamps such as germicidal UV and mercury UV lamps. Rates of movement of the substrate, distances from the lamps, and wattages of the lamps may vary. It will be appreciated that line speed, energy density and other variables of the curing process may depend on the particular formulation of the coating composition and the thickness to which it is applied, which may in turn depend on the substrate selected and the application for which it will be employed. Distances between the lamps and the coated substrate typically may range from about 1/16 in (0.15 cm) to about 8 in (20 cm), more typically between about 3/16 in. (0.5 cm) and about 4 in (10 cm). Line speeds typically are about 1 ft/min (0.3 m/min) to about 200 ft./min (61 m/min), more typically about 3 ft/min (0.9 m/min) to about 120 ft./min (37 m/min). Wattages of each of the Germicidal and mercury UV lights may vary from about 6 Watts/inch (2.4 W/cm) to about 600 Watts/inch (236 W/cm) to provide typical UV intensities of about 0.25 W/m² to about 1.5 W/m².

In some embodiments, substrates coated with the compositions described herein are treated to a multi-stage curing process. The first stage (pre-curing) entails treating the coated samples to UVC radiation from a germicidal lamp. In some embodiments, the precured sample is finally cured by UV radiation such as from a germicidal lamp, e.g. an amalgam germicidal lamp. In some embodiments, a mercury (Hg) lamp that emits radiation over one or more of UVA and UVB spectra is used in addition to the germicidal lamp. Germicidal lamps that may be employed include but are not limited to Germicidal Lamp Model. No. GML800A from American Ultraviolet Corp. that emits UVC radiation having a peak at 254 nm and a lower peak at 185 nm. Mercury lamps that may be employed include but are not limited to Aetek model no. M550395 lamp from MILTEC UV.

During precure, the coated flooring substrates may be exposed to radiation (e.g., UVC) over a temperature range of about 65° F. (18° C.) to about 150° F. (66° C.), typically about 75° F. (24° C.) to about 130° F. (54° C.). During final cure, the precured flooring substrates may be exposed to radiation over a temperature range of about 65° F. (18° C.) to about 170° F. (77° C.), typically about 75° F. (24° C.) to about 135° F. (57° C.).

Also during pre-cure, the coated flooring substrates may be exposed to UVC radiation in a variety of atmospheres such as air and inert atmospheres. In a preferred embodiment, the coated flooring substrate is exposed to UVC in an inert or low oxygen concentration environment. Inert atmospheres that may be employed include but are not limited to nitrogen, helium and argon. Similarly, the pre-cured samples may be final cured in a variety of atmospheres. Any of the methods described herein may produce products that have reduced total volatile organic components.

In addition to the performance benefits described herein, the present inventors have also discovered the manufacturing and sustainability benefits provided by the inventive methods described herein. For example, exemplary methods of the present invention consume less than one-third the electrical power consumed by conventional arc lamp curing methods.

In addition, a significant cost savings can be realized through the use of methods of the present invention based solely on the replacement cost for the bulbs which generate the radiation used in the curing process given that the service life of a UVC lamps is more than ten times longer than that of a mercury arc lamp.

Moreover, the ability to start and stop the production line without lag, is an additional benefit provided by the inventive methods of the present invention. Because arc lamps must be “shuttered”, curing methods which employ arc lamps are not afforded this benefit.

The inventive methods of the present invention also provide aesthetic and improved product quality benefits. Arc lamps emit IR radiation in addition to UV radiation. These emissions increase the heat associated with the process and often result in discoloration (e.g. yellowing) of the coatings produced thereby.

The invention will be described in greater detail by way of specific examples. The following examples are offered for illustrative purposes and are not intended to limit the invention in any manner. Those skilled in the art will readily recognize a variety of noncritical parameters, which can be changed or modified to yield essentially the same results.

### EXAMPLES

### Example 1

Coating compositions 1 through 5 are prepared in accordance with the formulations described in Table 1 (below). The compositions are prepared by mixing the resin components with any reactive diluents, amine synergists, surfactants and dispersing agents at room temperature under agitation. Thereafter, a photoinitiator is slowly added with agitation until all initiator is dissolved. The photoinitiator is added at room temperature or, in some cases, at 45° C. followed by returning to room temperature. Next, the flattening, i.e. matting, agents are added, except for any flattening agents already present in a self-matting resin. The flattening agents are slowly added to the formulation during agitation, followed by at least an additional 5 minutes of mixing. The formulations are discharged to brown glass jars for storage at room temperature.

TABLE 1

| | Coating Composition | | | | |
|---|---|---|---|---|---|
| | 1 | 2 | 3 | 4 | 5 |
| Ingredient | Wt. % | | | | |
| Acrylate component | 70.9 | 70.9 | 70.9 | 70.9 | 81.2 |
| Amine synergist | 2.2 | 2.2 | 2.2 | 2.2 | 2.5 |
| Surfactant | 0.6 | 0.6 | 0.6 | 0.6 | 0.7 |
| Photoinitiator | 2.9 | 2.9 | 2.9 | 2.9 | 3.3 |
| Flattening agent | 8.9 | 8.9 | 8.9 | 8.9 | 11.9 |
| Abrasive | 14.2 | 14.2 | 14.2 | 14.2 | — |
| Dispersing agent | 0.3 | 0.3 | 0.3 | 0.3 | 0.4 |

### Example 2

Substrates coated with the compositions described in Table 1 (above) are cured according to methods of the present invention and conventional arc lamp curing methods. The methods of the present invention are carried out in an inert environment wherein the oxygen concentrations ranged from 75 to 150 ppm, whereas the arc lamp curing is carried out in the ambient air environment. In general, the curing process with a conventional arc lamp is conducted in the ambient air environment since there typically is no significant improvement and benefit of using inert curing environment with the arc lamp curing process, which utilizes a longer wavelength light energy source. After the coated substrates are cured, the coatings are evaluated for performance. The results of these evaluations are described in Table 2 (below).

Stain resistance is measured by placing iodine on an area of the coated flooring. After a period of time, the area is cleaned with isopropyl alcohol. Color readings of the area are taken before and after the test. The degree of yellowing can be measured by use of a color/meter that measures tristimulas color values of ‘a’, ‘b’, and ‘L’ where color coordinates are designated as +a (red), −a (green), +b (yellow), −b(blue), +L(white), and −L(Black). More appropriate is to express the degree of yellowing as Delta b or difference in b values between initial and final values. A Delta b greater than 1 generally can be detected by the naked eye. Delta b (Δb) values are reported.

TABLE 2

| | | | | | 1 min | |
|---|---|---|---|---|---|---|
| Coating | Coating | | Total | Total | Iodine | Ballpoint |
| Compo- | Thickness | Cure | UVA | UVC | Staining | Stain |
| sition | (mil) | Method | (J/cm2) | (J/cm2) | (Δb) | (ΔE) |
| 1 | 1 | Arc lamp | 1.103 | 0.156 | 26.80 | 6.55 |
| 1 | 1 | Germicidal | — | 0.190 | 3.79 | 2.21 |
| 2 | 1 | Arc lamp | 1.103 | 0.156 | 24.63 | 5.94 |
| 2 | 1 | Germicidal | — | 0.190 | 4.81 | 1.85 |
| 3 | 1 | Arc lamp | 1.103 | 0.156 | 26.34 | 5.04 |
| 3 | 1 | Germicidal | — | 0.190 | 2.23 | 3.58 |
| 4 | 1 | Arc lamp | 1.103 | 0.156 | 22.34 | 11.3 |
| 4 | 1 | Germicidal | — | 0.190 | 2.92 | 1.75 |
| 5 | 0.5 | Arc lamp | 1.152 | 0.162 | 27.84 | 10.19 |
| 5 | 0.5 | Germicidal | — | 0.095 | 12.49 | 2.87 |
| 5 | 0.5 | Germicidal | — | 0.193 | 10.94 | 0.89 |

The data described in Table 2 (above) demonstrate that substrates coated by exemplary methods of the present invention provide an unexpected level of resistance to staining when compared to substrates possessing a wear layer produced according to standard are lamp curing methods.

The data is highly remarkable given the low level of energy that is delivered through germicidal curing lamps. These results far exceed expectations, as carrying out the conventional arc lamp curing method in an inert environment, rather than in room air, would not be expected to provide such an improvement in performance.

Infrared (IR) analysis of the cured substrates underscored another surprising result derived from the claimed invention. Specifically, IR analysis of the coatings produced by the claimed methods showed “through-curing”, rather than superficial curing of the outer surface. The extent to which the coatings produced by methods of the present invention were cured was unexpected given the understanding in the art that radiation of germicidal wavelength provides only superficial curing.

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A method for producing a wear layer on a substrate comprising:
applying a radiation curable composition comprising an acrylate component to a surface of a substrate; and
irradiating the substrate to which said composition has been applied with a source of radiation having a wavelength from 100-280 nm, to form a wear layer; and
wherein the substrate to which the coating has been applied is irradiated for a time and intensity sufficient to provide a total energy density of from about 0.1 J/cm² to about 0.4 J/cm².

2. The method of claim 1, further comprising the step of pre-curing the radiation curable composition prior to the step of applying said composition to the substrate.

3. The method of claim 2, wherein the pre-curing comprises irradiating the radiation curable composition with a source of radiation having a wavelength of from 100-280 nm.

4. The method of claim 1, further comprising the step of heating said substrate to a temperature of from about 65° F. to about 150° F. prior to irradiating said composition.

5. The method of claim 1, wherein the composition further comprises from about 0.1 to about 25 wt. % of an amine synergist.

6. The method of claim 1, wherein the composition further comprises an abrasive.

7. The method of claim 1, wherein the nitrogen flow rate is about 40 Nm³/hour.

8. The method of claim 1, wherein the coated substrate is irradiated in an environment having an oxygen concentration of from about 50 to about 1500 ppm per square meter of material surface.

9. (canceled)

10. The method of claim 1, wherein the coated substrate is irradiated at a line speed of from about 10 ft./min to about 60 ft./min.

11. (canceled)

12. The method of claim 12, wherein the coated substrate is irradiated at a line speed of 38 ft./min.

13. The method of claim 1, wherein the composition comprises from about 65 wt. % to about 95 wt. % of an acrylate component.

14. The method of claim 1, wherein the acrylate component comprises an acrylate selected from polyester acrylate; urethane acrylate; epoxy acrylate; silicone acrylate; and a combination of two or more thereof.

15. The method of claim 1, wherein the source of radiation used to irradiate the substrate to which said composition has been applied, comprises an amalgam germicidal lamp.

16. (canceled)

17. The method of claim 1, wherein the substrate to which the coating has been applied is irradiated a plurality of times.

18. The method of claim 17, wherein the substrate to which the coating has been applied is irradiated with at least one of UVA, UVB, UVC or VUV radiation.

19. The method of claim 2, wherein the pre-curing is carried out at a temperature of from about 110° F. to about 125° F.

20. (canceled)

21. The method of claim 1, wherein the radiation curable composition is applied to the substrate in an amount sufficient to provide a coating having a density of from about 1 g/m² to about 3 g/m².

22. The method of claim 1, wherein the composition further comprises at least one of a photoinitiator, a flattening agent, and an ink.

23. (canceled)

24. The method of claim 15, wherein the substrate to which said composition has been applied is irradiated with a source of radiation having a peak of 254 nm and a lower peak at 185 nm.

25. (canceled)
